(19) United States
(12) Patent Application Publication
(10) Pub. No.: US 2024/0111027 A1
(43) Pub. Date: Apr. 4, 2024

(54) ANALYZING ELECTRO-OPTICAL IMAGE

(71) Applicant: The Aerospace Corporation, El Segundo, CA (US)

(72) Inventor: Matthew C. Britton, Rancho Palos Verdes, CA (US)

(73) Assignee: The Aerospace Corporation, El Segundo, CA (US)

(21) Appl. No.: 17/936,342

(22) Filed: Sep. 28, 2022

(51) Int. Cl. G01S 7/481; G01S 3/786

(52) U.S. Cl. CPC G01S 7/4816; G01S 3/7867; G01S 7/4817

(57) ABSTRACT

Analyzing electro-optical imagery from a telescope observing one or more satellites includes capturing one or more images of a plurality of stars and the one or more satellites, and sequentially or randomly selecting each one of a plurality of diagonal lines of pixels in the one or more images. The plurality of diagonal lines of pixels represent one of the plurality of stars in the one or more images. Additionally, a moving average filter is applied to the selected one of the plurality of diagonal lines of pixels to find a location of one of the plurality of start on an x- and y-axis coordinate. Furthermore, the location of the one of the plurality of stars is provided in the one or more captured images to be cross referenced with angular coordinates and radiometric quantities in stellar catalogs.

### FIELD

The present invention relates to electro-optical imagery, and more particularly, to an embedded algorithm configured to analyze electro-optical imagery from telescopes observing satellites.

### BACKGROUND

When a telescope is observing a satellite, the telescope may track the satellite such that the telescope points towards the satellite while the satellite moves. This observing technique is commonly termed “rate-track mode”. Because the satellite is moving against a background starfield and because the stars are moving at a different rate than the satellite, the stars appear as streaks. See, for example, FIG. 1, which illustrates an image 100 showing a satellite 105 moving with stars 110 streaking in the background of image 100.

Two objectives for observing a satellite 105 are to measure its brightness and angular location on the sky. These measurements are useful in 1) characterizing satellite 105 and 2) establishing a tracking solution for the telescope. The latter is useful in providing real-time feedback to continuously update telescope pointing to stabilize the location of satellite 105 within image 100.

When observing in rate-track mode, stars 110 move through the field of view in successive images, forming a streak 100 in each image. The angular locations of stars 110 are catalogued, and serve as reference points to measure the angular location of satellite 105 on the sky and as photometric calibrators to measure the brightness of satellite 105. Consequently, it is important to measure the brightness and locations of stars 110 within image 100. Likewise, it is important to measure the brightness and location of satellite 105 in image 100.

Current technological approaches to this measurement process are limited in two aspects. First, conventional algorithms postprocess imagery. These algorithms transfer an entire image into computer memory and then analyze this image to separate stellar streaks from the satellite signal. These algorithms are unable to process the images rapidly enough to continuously update telescope pointing in real time. Second, by requiring postprocessing of these imagery, current algorithms require that the entire image must be available for postprocessing to occur. This may entail transfer of the image from the point of acquisition to a different location for postprocessing. For example, the imagery may be transferred over network to a remote filesystem or transferred via free-space communication systems from a space vehicle to a ground station. The data rates at which the images are acquired may exceed the network bandwidth by large factors. This condition degrades the ability of the system as a whole to operate at full capacity, as the communication bottleneck effectively limits its operational uptime to less than 100%.

Accordingly, an improved embedded algorithm for analyzing electro-optical imagery may be beneficial.

### SUMMARY

Certain embodiments of the present invention may provide solutions to the problems and needs in the art that have not yet been fully identified, appreciated, or solved by current electro-optical image processing technologies. For example, some embodiments of the present invention pertain to electro-optical image processing, and more specifically, an embedded algorithm configured to identify the location of a satellite and stars in the image. This is accomplished by separating light from the satellite and the stars for the purposes of feedback control on the satellite. By separating the light, the location of the satellite with respect to the stars can be measured. Since the location of the stars are tabulated in stellar catalogs, the location of the satellite is determined in any given image by referencing its location to the stars present in that image. To accomplish this in real time, a field programmable array (FPGA) processor or an embedded processor may execute the image processing without saving data (i.e., data with blank pixels).

In an embodiment, a computer-implemented method for analyzing electro-optical imagery from a telescope observing one or more satellites is provided. The method includes capturing one or more images of a plurality of stars and the one or more satellites. The method further includes sequentially or randomly selecting each one of a plurality of diagonal lines of pixels in the one or more images. The plurality of diagonal lines of pixels represent one of the plurality of stars in the one or more images. The method also includes applying a moving average filter to the selected one of the plurality of diagonal lines of pixels to find a location of one of the plurality of start on an x- and y-axis coordinate. The method further includes providing the location of the one of the plurality of stars in the one or more captured images to be cross referenced with angular coordinates and radiometric quantities in stellar catalogs.

In another embodiment, a non-transitory computer readable medium includes a computer program. The computer program is configured to execute capturing one or more images of a plurality of stars and the one or more satellites, and sequentially or randomly selecting each one of a plurality of diagonal lines of pixels in the one or more images. The plurality of diagonal lines of pixels represent one of the plurality of stars in the one or more images. The computer program is further configured to execute applying a moving average filter to the selected one of the plurality of diagonal lines of pixels to find a location of one of the plurality of start on an x- and y-axis coordinate. The computer program is further configured to execute providing the location of the one of the plurality of stars in the one or more captured images to be cross referenced with angular coordinates and radiometric quantities in stellar catalogs.

In yet another embodiment, an apparatus for analyzing electro-optical imagery from a telescope observing one or more satellites includes at least one processor and memory comprising a set of instructions. The set of instructions, with the at least one processor, is configured to execute capturing one or more images of a plurality of stars and the one or more satellites, and sequentially or randomly selecting each one of a plurality of diagonal lines of pixels in the one or more images. The plurality of diagonal lines of pixels represent one of the plurality of stars in the one or more images. The set of instructions, with the at least one processor, is further configured to execute applying a moving average filter to the selected one of the plurality of diagonal lines of pixels to find a location of one of the plurality of start on an x- and y-axis coordinate. The set of instructions, with the at least one processor, is further configured to execute providing the location of the one of the plurality of stars in the one or more captured images to be cross referenced with angular coordinates and radiometric quantities in stellar catalogs.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates an image showing a satellite moving with stars streaking in the background of image 100.

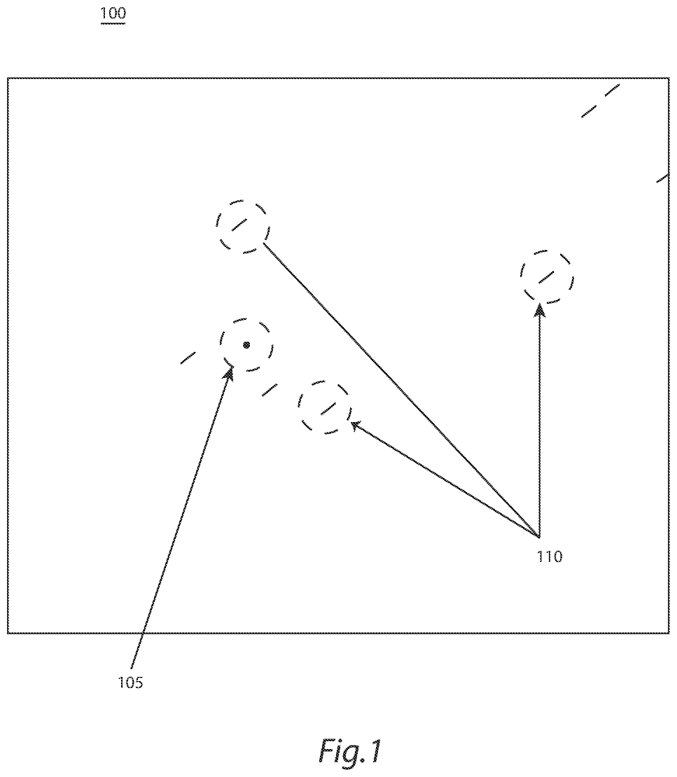

FIG. 2 illustrates an electro-optical image 200 drawn from a sequence of electro-optical images, according to an embodiment of the present invention.

FIG. 3 illustrates a sequence of images, according to an embodiment of the present invention.

FIG. 4 illustrates a single image, according to an embodiment of the present invention.

FIG. 5 illustrates an image with horizontal rows of pixels, according to an embodiment of the present invention.

FIG. 6 is an image illustrating vertically streaking stars in an array after the pixels within an image have been sorted and displayed vertically, according to an embodiment of the present invention.

FIG. 7 is a diagram illustrating 1D arrays from a succession of four images (i.e., Image #1, Image #2, Image #3, and Image #4), according to an embodiment of the present invention.

FIG. 8 illustrates an image showing stellar sensitivity, according to an embodiment of the present invention.

FIG. 9 illustrates an image showing a benefit of distinguishing between stellar and RSO photons, according to an embodiment of the present invention.

FIG. 10 illustrates an image showing RSO search sensitivity, according to an embodiment of the present invention.

FIG. 11 is a diagram illustrating a telescope operating in rate track mode and using a camera to image a satellite (not shown), according to an embodiment of the present invention.

FIG. 12 is a flow diagram illustrating a method for analyzing electro-optical imagery from a telescope observing one or more satellites, according to an embodiment of the present invention.

### DETAILED DESCRIPTION OF THE EMBODIMENTS

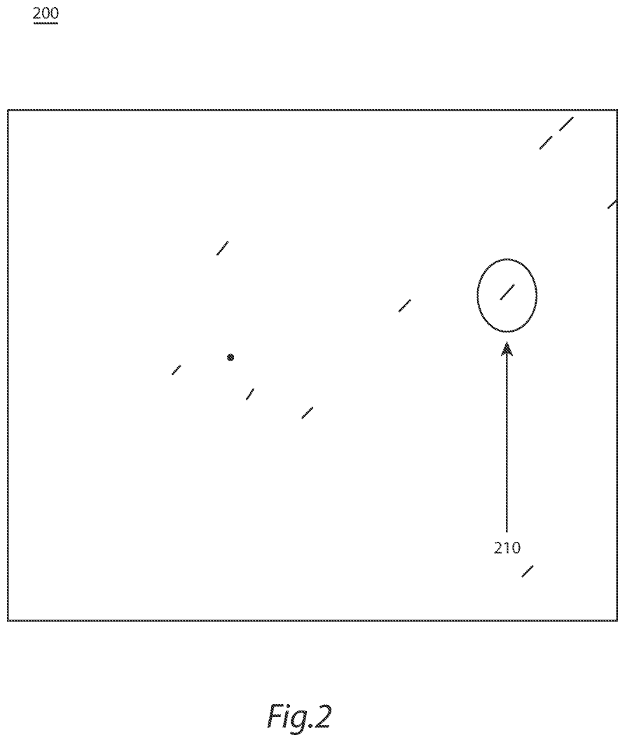

Some embodiments generally pertain to an embedded algorithm for analyzing electro-optical imagery from telescopes observing satellites. The algorithm may be embedded in the telescope, for example. FIG. 2 illustrates an electro-optical image 200 drawn from a sequence of electro-optical images, i.e., hundreds of sequential electro-optical images that may be acquired at frame rates between ˜1 and ˜1000 frames per second. It should be noted that megapixel cameras are now ubiquitous and generate data at rates that can exceed gigabytes per second. Recording and transferring data at these rates for postprocessing is time-consuming and expensive. Such a strategy also precludes the possibility of real-time decision support. To overcome these limitations, an algorithm may reduce the data in real-time and retain only the relevant information rather than raw pixels in the electro-optical images.

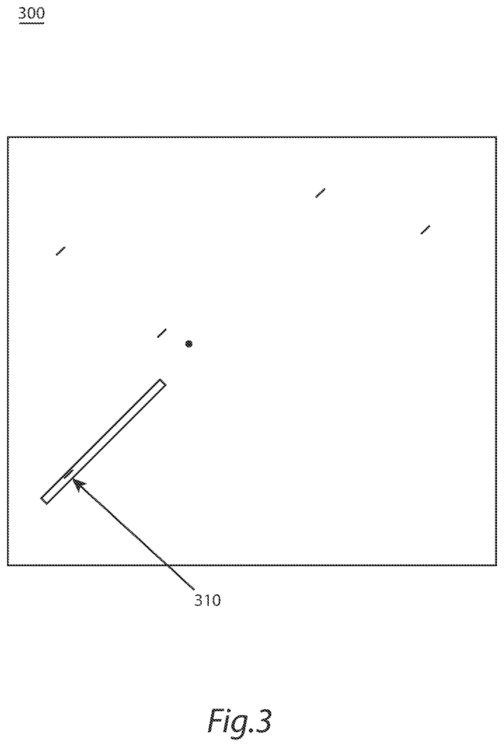

It should be noted that stars moving through the field are a 1 dimensional (1D) problem and not a 2 dimensional (2D) problem. For instance, in a sequence of images, star 210 follows a diagonal line in successive images and appears at regularly spaced intervals. It should also be noted that the direction of the line is set by the telescope's tracking rate. In this embodiment, star 210 appears at a streak in image 200 because the camera on the telescope acquires an image by opening and then closing an electronic shutter. This time interval is called the exposure time. During this exposure time, the telescope drives the camera at an angular rate that differs from that of star 210, so that star 210 forms a streak in the image. See FIG. 3, which illustrates a sequence of images 300, according to an embodiment of the present invention. Since the telescope tracking rate, the stellar rate, and the exposure time are known, the streak length and orientation (i.e., of star 310) are known and the technique reduces to the analysis of a 1D problem, i.e., extract one diagonal line in this example.

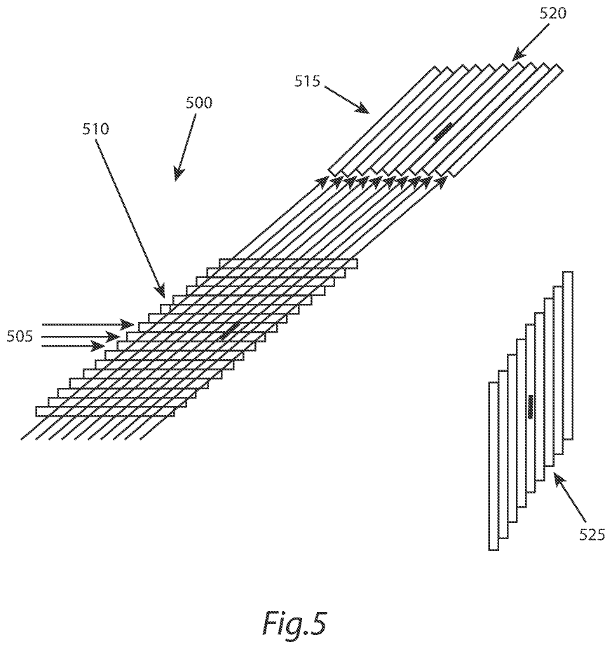

It should be appreciated that FPGA may process a batch of diagonal lines simultaneously, where the number of lines depend on the available resources and programmable logic in the FPGA. In some embodiments, the pixel data coming over the DMA pipeline is serialized so that pixels in horizontal rows come out of the pipe in sequence. These pixels are sorted into columns by “deserializing” the pixels. For example, the FPGA may deserialize 1 to 16, so that horizontal rows of 16 adjacent pixels get sorted into 16 independent channels. This occurs in a loop, so that each successive horizontal row is sorted into the correct channel. See, for example, FIG. 5. Once sorted, the moving average filter is applied to each channel in parallel. In this example, 16 diagonal lines may be processed simultaneously. This would be followed by the next 16 diagonal lines and so forth until the entire image is processed. This happens to be the 1 to 16 deserialization used in the calculation under Equation (1).

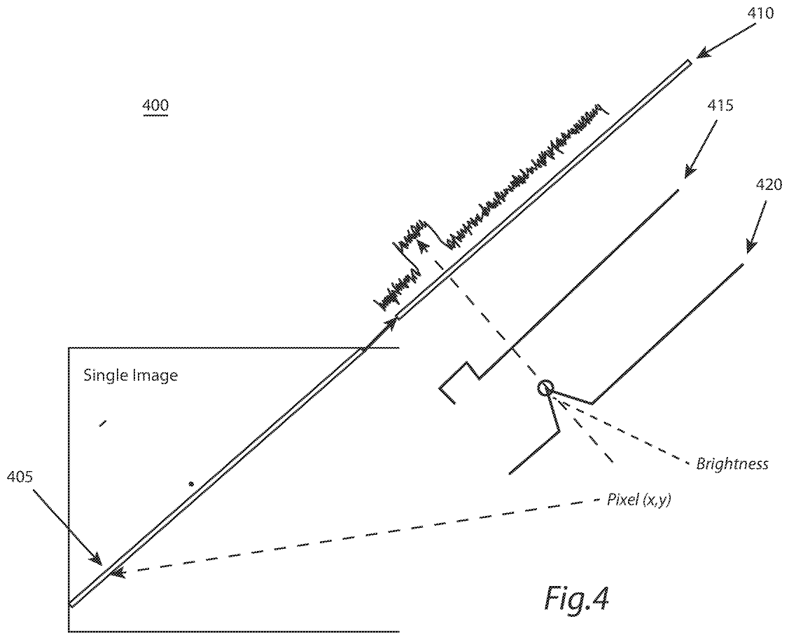

FIG. 4 illustrates a single image 400, according to an embodiment of the present invention. In this embodiment, a diagonal line of pixels is selected and a moving average filter is applied to find the (x,y) location of the streak 405. For example, a diagonal line in image 400 is extracted, and the diagonal line is cross correlated against a template, for which the size is known (i.e., since the length of the streak is known). The cross-correlation may produce or show a peak, which identifies the location of the star. This is an embodiment of the subject application, i.e., the recognition of knowing the direction and length of the streak.

FIG. 5 illustrates an image 500 with horizontal rows of pixels 505, according to an embodiment of the present invention. In some embodiments, a subset of pixels from each horizontal row of pixels is extracted 510, to line the subset of pixels up in columns 515. Since the orientation of the streak is known, the selected subset of pixels may be shifted horizontally to match the known diagonal path traced by the streak. This path is known because the tracking rate of the telescope is known relative to the sidereal rate at which the stars move. In FIG. 5, the streak is shown as a diagonal line segment from lower left towards upper right. In each successive row of the image, a subset of pixels is selected to shift the starting pixel 510 horizontally and to the right to match the diagonal line. This transforms the diagonal line containing the streak within the 2D image into a set of 1D arrays of pixels 515, one of which 520 contains the streak. The 1D outcome of this pixel resorting operation is apparent when the arrays are displayed vertically 525. This pixel sorting operation accomplishes the conversion of the 2D problem into a 1D problem.

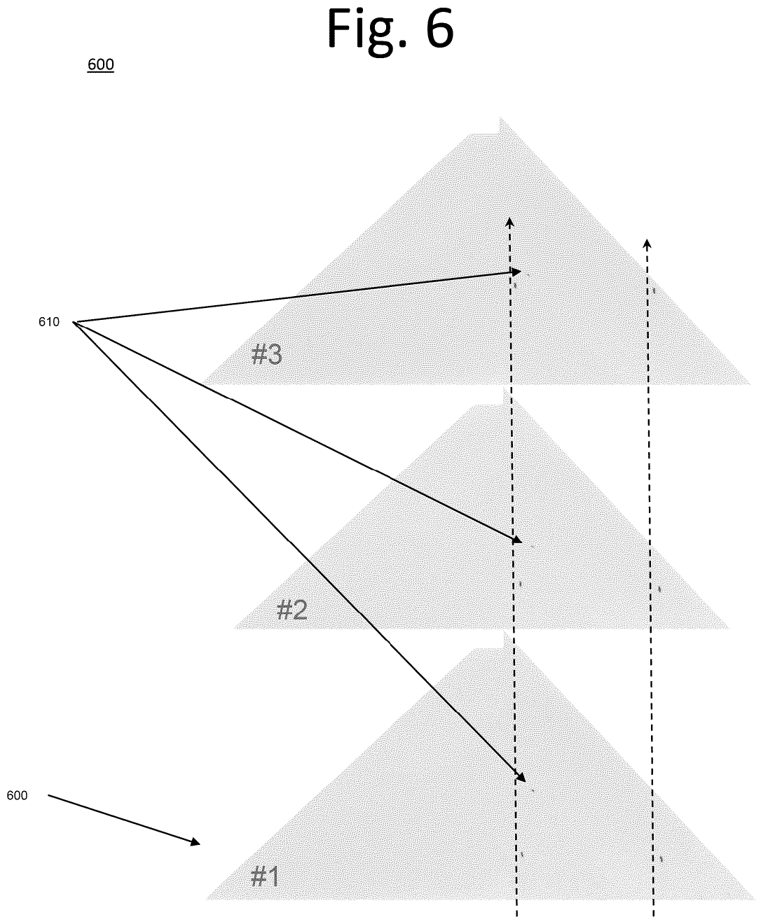

In some embodiments, after identifying the locations of the starting pixels 510, scatter-gather direct memory access (DMA) is performed on an image resident in computer memory. Scatter-gather DMA is a technique to transfer contiguous blocks of data from computer memory into an embedded processor such as an FPGA. In this embodiment, scatter-gather DMA is used to accomplish the pixel sorting operation as part of the data transfer into the FPGA. In this operation, a host processor writes the memory address(es) of the starting pixels and the number of pixels to be transferred into a table, which is stored in computer memory (or a database). The FPGA reads this table to identify segments of memory to transfer from computer memory and performs the scatter-gather DMA to accomplish the transfer. Upon transfer, each horizontal row of pixels is deserialized into a set of first-in-first-out (FIFO) channels so as to perform the pixel sorting operation. See, for example, FIG. 6, which is an image 600 illustrating vertically streaking stars in an array after the pixels within an image have been sorted and displayed vertically as in 525. FIG. 6 shows a sequence of three resorted displays in which stars 605 move vertically and the satellite 610 remains stationary. This is the nature of the use of scatter-gather DMA in this pixel sorting technique, i.e., arranging the rows to align with the diagonal lines of FIG. 5 as an outcome of the data transfer to the FPGA. Upon alignment of the rows of pixels, there are a series of 1D problems. This allows for cross-correlation with a template in 1D. FIG. 6 also demonstrates the method for distinguishing between photons from stars and photons from satellites: in a sequence of images the former yield streaks that move vertically while the latter yield points that remain stationary.

In some embodiments, an FPGA transfers data from computer memory in a time interval t_{xfer} specified by the following equation.

t_{xfer}=P×L×T Equation(1)

where P is the subset of pixels within each row, L is the number of diagonal lines, and T is the transfer time per pixel. For example, a 200 MHZ FPGA sorts 16 diagonal lines of pixels via scatter gather DMA while transferring pixels from computer memory to FPGA at the rate of one pixel per 5 ns clock cycle. In this example, P=16, L=2048 and T=5 ns, yielding a transfer time t_{xfer}=163840 ns=164 microseconds. Also, in this example, P=16 was chosen as representative of FPGA capacity for deserializing an array of pixels.

Using the above equation, a 2048×2048 image processed in sequential batches of 16 diagonal lines would complete, for example, in 21 milliseconds (e.g., 164 microseconds*[2048/16]). In this example, pixels may be sorted during transfer into the FPGA at a rate of 21 milliseconds/image, equivalent to 47 images per second.

Computing the moving average may consume fewer clock cycles and may interleave with transfer of the next set of diagonal pixel lines. This way extra processing time is not consumed.

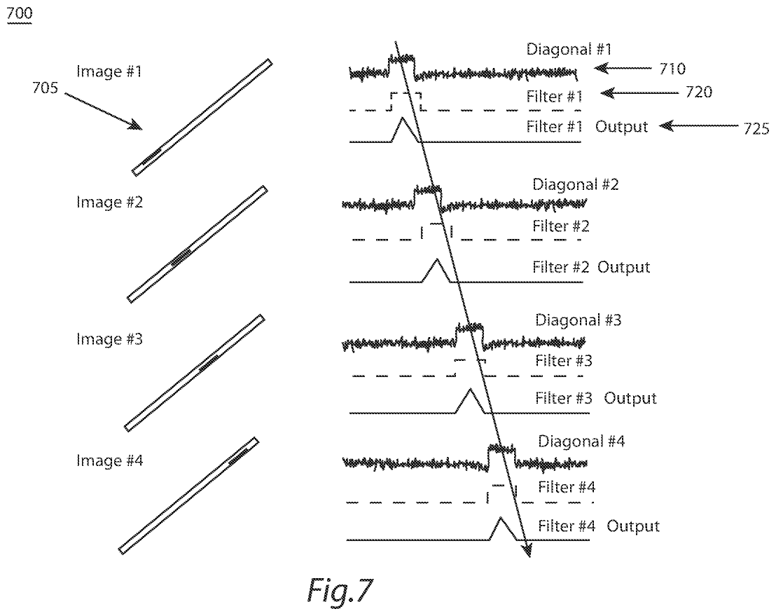

The pixel sorting technique described above collates pixels from stellar streaks into 1D arrays. In successive images these streaks shift along the 1D array. FIG. 7 illustrates a diagram 700 showing 1D arrays from a succession of four images 705 (i.e., Image #1, Image #2, Image #3, and Image #4), according to an embodiment of the present invention. In each 1D arrays, a streak is depicted as a rectangular function with a random contribution due to noise 710. As the telescope acquires successive images, this rectangular function advances from left to right in FIG. 7 (see line 715), corresponding to the movement of the star along diagonal line in the sequence of 2D images. A moving average filter 720 is applied to each 1D array. Since the telescope tracking rate, the stellar rate and the exposure time are known, the shape of this moving average filter and its displacement from one image to the next is known. The peaks identified in the output of the moving average filter 725 provide the pixel coordinates of the star in the original 2D image.

The pixel coordinates measured using this moving average filter technique may be cross referenced with stellar catalogs, which contain the angular coordinates (i.e., right ascension and declination) and radiometric quantities (i.e., stellar irradiance) of the stars. This permits conversion from pixel coordinates and detector intensity units to angular coordinates (RA/DEC) and radiometric units (irradiance).

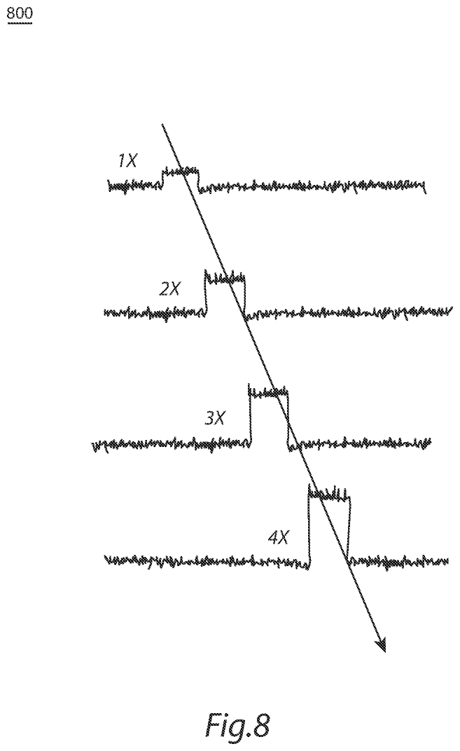

FIG. 8 illustrates an image 800 showing stellar sensitivity, according to an embodiment of the present invention. In this embodiment, image 800 shows how the signal is added up from the successive frames. For example, the algorithm may shift the diagonal pixel lines by the known number of pixels and then coadd. In the example of tracking a geostationary satellite using a detector with 2048×2048 pixels at 3.9 microradians per pixel and a 1 second exposure time, a star requires 53 successive images to traverse the longest diagonal. In this example, coaddition increases signal-to-noise ratio (SNR) by SQRT(53), equaling 7.3. Thus, this algorithm integrates stellar signal over all images in which the star appears, allowing for the detection of fainter stars.

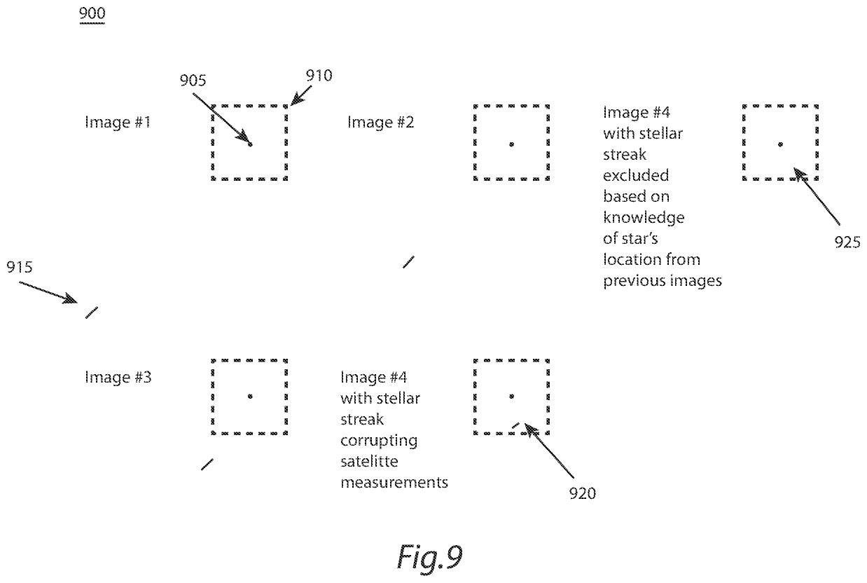

FIG. 9 illustrates an image 900 showing a benefit of distinguishing between stellar and RSO photons, according to an embodiment of the present invention. In this embodiment, the algorithm distinguishes between stellar and RSO photons by identifying the stars moving along known diagonals at a known rate from image to image, as discussed in FIGS. 8 and 9. RSO photons do not move in this way, and so they are not detected using the moving filter algorithm described in FIGS. 8 and 9. Image 900 shows a satellite 905 imaged in rate-track mode and a track box 910 centered on the satellite. A measurement of the satellite's pixel location is obtained by centroiding within the track box. A measurement of the satellite's brightness is obtained by integrating the detector counts within the track box. Stars appear as streaks 915 that move along diagonal lines in successive images. Streaks in images 1-3 do not affect the measurement of satellite location and brightness, but the streak in image 4 has entered the track box and would corrupt these measurements. Some embodiments permit detection and identification of the streaks in images 1-3, before this streak enters the track box in image 4. Based on this detection, the pixels in image 4 may be excised, i.e., those that contain the streak prior to performing the measurement of the satellite location and brightness. Distinguishing between photons from stars and satellites in this way restores the fidelity of the satellite location and brightness measurements otherwise corrupted by streaks.

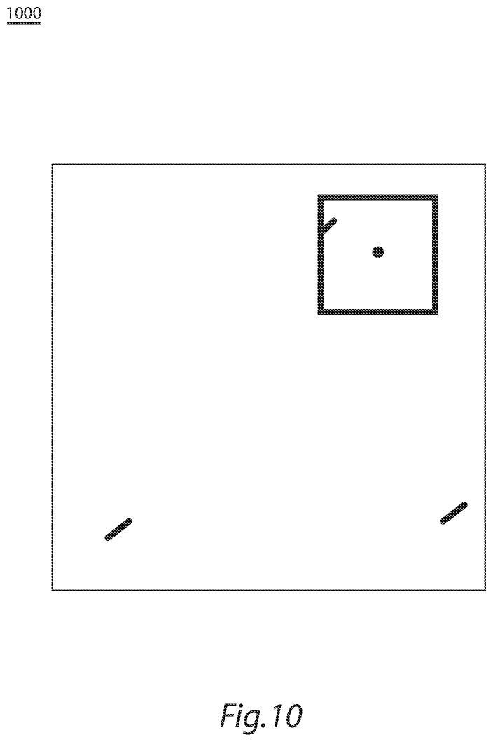

FIG. 10 illustrates an image 1000 showing RSO search sensitivity, according to an embodiment of the present invention. In some embodiments, the algorithm may improve RSO detection threshold by coadding the pixels in the track box over multiple images after excising the star. Because the track box shown in image 1000 can be extracted and because the excision of the pixels associated with the star is known, the track boxes can be coadded, i.e., the track boxes can be added from image to image. This increases the sensitivity limit for detecting faint satellites.

It should be noted that the algorithm is an embedded algorithm operating in hard real time. Hard real time is a term of art in the field of controls, indicating that there is a hard upper limit to the interval in which calculations will be completed. Any violation of this upper limit is considered a system failure. In the context of this invention, an FPGA provides a hard real time guarantee for the time required to process a single image. This processing time is dictated by the transfer time required for the scatter-gather DMA transfer plus overhead in performing the moving average filter. Hard real time guarantees are important in electro-optic feedback control systems, as they ensure the ability of such systems to reject errors to a required level of precision. Control strategies that rely on measurements of the satellite location and brightness are best implemented at low latency with a hard real time guarantee. Examples of control systems that may rely on electro-optic feedback include gimbal pointing/tracking and propulsion systems.

Most of the pixels in these images are not illuminated by an object and carry no information. This algorithm retains only the stellar and RSO pixel locations and brightnesses. The reduction in data volume that arises from real-time analysis yields significant relief to comm requirements. (e.g., space to ground). An equation representing the reduction in data volume offered by this invention may be written as

$$[ \begin{matrix}data \\ reduction \\ factor\end{matrix} ] = \frac{[ \begin{matrix}Number \\ of pixels \\ per image\end{matrix} ] [ \begin{matrix}Number \\ of bytes \\ per pixel\end{matrix} ]}{[ \begin{matrix}Number of \\ objects in \\ the image\end{matrix} ] [ \begin{matrix}two \\ measurements \\ of pixel \\ location \\ plus one \\ measurement \\ of brightness\end{matrix} ] [ \begin{matrix}Number of \\ bytes per \\ measurement\end{matrix} ]} \qquad Equation ( 2 )$$

As an example, consider a 2048×2048 image containing 50 stars and an RSO. Assume two bytes per pixel and eight bytes per measurement. In this example, the algorithm reduces data by a factor of

$$[ \begin{matrix}data \\ reduction \\ factor\end{matrix} ] = \frac{2048 * 2048 * 2 bytes / pixel}{( 50 + 1 ) * 3 * 8 bytes / measurement} = 20 , 560 \qquad Equation ( 3 )$$

The data reduction factor in the above example is ˜20,000. This factor is sufficient to reduce data rates from values of order 1 Gigabyte/sec to values of order 100 kilobytes/second. This reduction in data rate enables communication between space to ground, ground to ground, and space to space without saturating bandwidth of the communication link.

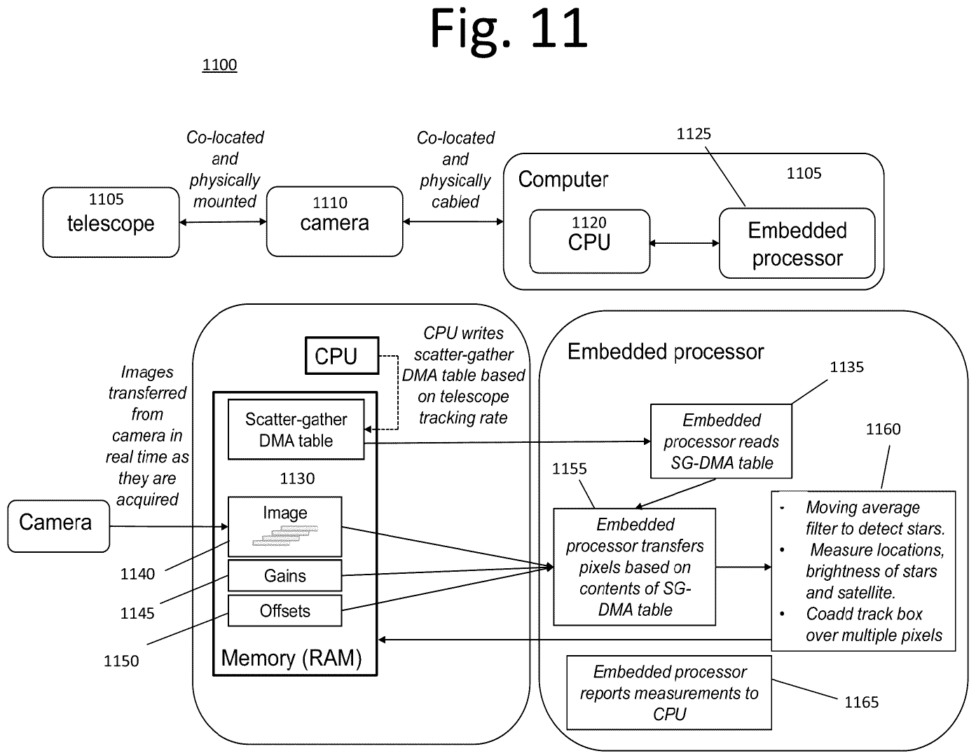

FIG. 11 is a diagram illustrating a telescope 1105 operating in rate track mode and using a camera 1110 to image a satellite (not shown), according to an embodiment of the present invention. Images from camera 1110 are transferred to a computer 1115 hosting a central processing unit (CPU) 1120 and an embedded processor 1125. Based on the tracking rate of telescope 1105 and the exposure time of camera 1110, CPU 1120 writes a scatter-gather DMA table to computer memory 1130. Embedded processor 1125 reads table 1135 to set up the DMA transfer.

At this point, camera 1110 begins acquiring images, which are transferred into computer memory 1130 and stored as pixel data 1140. It is understood by those skilled in this art that pixel gains and offsets are used to calibrate the images. Pixel gains 1145 and offsets 1150 are also stored in memory 1130. As images are written into memory 1130, embedded processor 1125 performs the scatter-gather DMA to transfer 1155 image data, gains and offsets so as to reorder the pixels. The image data are calibrated, the moving average filter is applied to measure locations and brightness 1160 of stars and the satellite, and the track box is coadded to obtain an integrated exposure. Embedded processor 1125 writes results 1165 back to memory 1130 where they are retrieved by CPU 1120 and logged for comparison to the stellar catalogs.

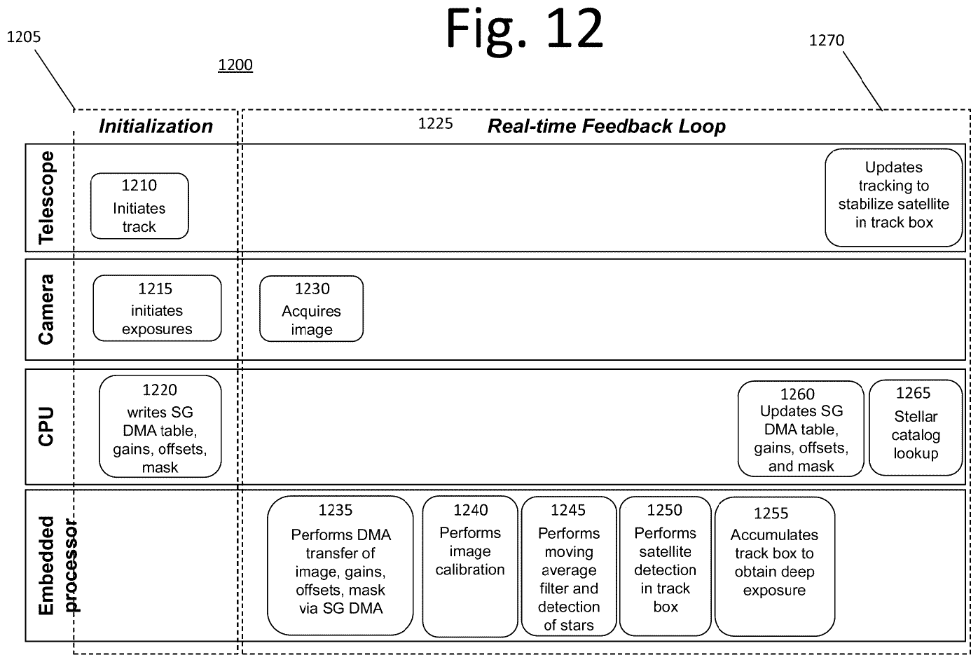

FIG. 12 is a flow diagram illustrating a method 1200 for analyzing electro-optical imagery from a telescope observing one or more satellites, according to an embodiment of the present invention. In this embodiment, time advances from left to right in this diagram. In FIG. 12, an initialization stage 1205 is illustrated in which a telescope, camera, and CPU initiate track on a satellite. In this initialization stage, the telescope initiates track 1210 based on a model for the satellite's trajectory, the camera initiates exposures 1215, and the CPU writes a scatter-gather DMA table 1220 based on the telescope's tracking rate. Also shown in FIG. 12 is a flow diagram for the real-time feedback loop 1225 portion of the analysis. This portion is executed repeatedly until the end of the observation. In this portion, the camera acquires a single image 1230. The embedded processor transfers this image and the pixel gains, offsets, and mask required for calibration via scatter-gather DMA 1235. The scatter-gather DMA accomplishes the diagonalization of the image as shown in FIG. 6. The embedded processor performs gain and offset correction and applies a mask on a per-pixel basis to calibrate the image 1240.

The embedded processor then applies a moving average filter and performs detection of stars 1245 along every diagonal in the image. An example of detection along a single diagonal is shown in FIG. 7. The embedded processor then performs a detection of the satellite within the track box 1250 as indicated in FIG. 9. This detection determines how the telescope tracking solution is to be updated so as to stabilize the satellite within the track box. The embedded processor can optionally accumulate the track box from successive images to form a deep exposure of the satellite 1255.

Based on the locations of the stars in the image and the satellite location, the CPU updates the scatter-gather DMA table to reflect an updated tracking solution 1260. The CPU may also update the mask to eliminate stars that will enter the track box in the next frame 925. The CPU may optionally update the gains and offsets to account for variability during the observation. The CPU cross-references the detected stars against a stellar catalog to obtain the absolute angular coordinates of the satellite and its absolute brightness 1265. The telescope then updates its track solution that stabilizes the satellite in the track box 1270. This analysis loop is then repeated on the next camera image 1230.

The process steps performed in FIG. 12 may be performed by a computer program, encoding instructions for the processor(s) to perform at least part of the process(es) described in FIG. 12, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system to implement all or part of the process steps described in FIG. 12, which may also be stored on the computer-readable medium.

The computer program can be implemented in hardware, software, or a hybrid implementation. The computer program can be composed of modules that are in operative communication with one another, and which are designed to pass information or instructions to display.

It should be appreciated that there are several key advantages in this image analysis technique.

First, this technique described herein allows classification of stellar and target photons. This allows the algorithm to distinguish a satellite within a crowded stellar field, and to distinguish individual stars within this field.

Second, the algorithm permits a hard-real time implementation, and operates at frame rates higher than are currently available. High frame rates are important in electro-optical feedback control algorithms because the efficacy of a tracking algorithm to suppress track errors improves as the time between corrections is reduced. Specifically, the control system acts as a high-pass filter with 3 dB cutoff frequency proportional to frame rate. A control system operating at higher frame rate rejects more of the disturbance spectrum, thereby better stabilizing the satellite. Equation (1), in the example above, is used to demonstrate operation at 50 frames per second: approximately 50 times faster than current best practice of roughly one frame per second.

Third, the algorithm reduces the data volume, enabling transmission of the results over finite-bandwidth networks. Equation (2), in the example above, is used to demonstrate a reduction in data volume by a factor of 20,560. This reduces data loads of current-generation focal plane arrays from Gigabytes per second to hundreds of kilobytes per second. Rates of hundreds of kilobytes per second can be supported in geographically dispersed networks or free-space optical communication links, whereas rates of Gigabytes per second are not supported.

It should be appreciated that there are several applications that will benefit from this algorithm.

For example, detection of faint satellites in crowded fields benefits directly from the ability of this algorithm to accumulate track box exposures over multiple images in a crowded stellar field. A tiled search can be performed by shifting the track box through a series of adjacent fields. This allows a deep search over a field of view larger than the size of the track box.

Similarly, sensitivity to a particular orbital regime may be performed by selecting the telescope tracking rate for optimal sensitivity against a hypothesized satellite angular velocity. Using a series of telescope tracking rates and accumulating track box images at each rate yields a grid search in satellite angular velocity space. Observations from these two search techniques may be evaluated in real time for candidate detections using the above algorithm.

Analogous the function of a star tracker, this algorithm identifies stars and cross-references them against stellar catalogs allows real-time determination of the pointing coordinates of the telescope. Currently, star trackers are separate electro-optic systems unrelated to the instrumentation collecting on the satellite. Unlike a star tracker, this algorithm is applied to the image data containing the satellite. This permits metric and photometric analysis of the satellite in real-time using a single electro-optical instrument.

Guidance systems can use electro-optical feedback for guidance control. Such guidance control systems are used for proximity operations and station keeping among satellites in orbit. This real-time algorithm permits guidance control by updating the guidance system on one satellite to maintain orientation relative to another satellite by stabilizing the satellite's image in a track box. This stabilization occurs by measuring the discrepancy using the algorithm described above and exercising a propulsion system to reduce the error.

Satellite laser ranging systems and free space optical communications systems require a transmit laser to illuminate the satellite. Such systems can operate on links from ground to space, air to space, or space to space. In these applications the satellite is imaged against a background field of stars. In order to establish and maintain the link, the laser illuminator must maintain accurate pointing to illuminate the satellite. This algorithm provides a hard real time estimate of satellite location for pointing the illuminator from a ground station, airplane, or another satellite.

Space domain awareness sensors, guidance control systems, satellite laser ranging systems, and free-space optical communications systems that deliver telemetry data over network for real-time decision support benefit from the reduction in data volume enabled by this algorithm. This decision support can occur in a data center that is geographically removed from the electro-optical system. This data center may receive telemetry data from electro-optical systems distributed over the earth or in space, fusing these telemetry data to enable effective decision support. The reduction in data volume afforded by this algorithm enables the data center to ingest less data volume. This reduces latency in data transfer and processing and shortens the decision timeline.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method for analyzing electro-optical imagery from a telescope observing one or more satellites, the method comprising:
capturing one or more images of a plurality of stars and the one or more satellites;
sequentially or randomly selecting each one of a plurality of diagonal lines of pixels in the one or more images, the plurality of diagonal lines of pixels represent one of the plurality of stars in the one or more images;
applying a moving average filter to the selected one of the plurality of diagonal lines of pixels to find a location of one of the plurality of start on an x- and y-axis coordinate; and
providing the location of the one of the plurality of stars in the one or more captured images to be cross referenced with angular coordinates and radiometric quantities in stellar catalogs.

2. The computer-implemented method of claim 1, further comprising:
for each of the one or more captured images,
extracting a subset of pixels from each horizontal row of pixels in order to line the extracted subset of pixels with column.

3. The computer-implemented method of claim 2, wherein the extracting the subset of pixels comprising shifting the selected subset of pixels horizontally to match a known diagonal path traced by a streak representing the one of the plurality of stars.

4. The computer-implemented method of claim 3, wherein the shifting the selected subset of pixels comprising shifting a starting point of the selected subset of pixels horizontally and to the right to match the one of the plurality of diagonal lines of pixels, thereby transforming the one of the plurality of diagonal lines of pixels containing the streak within a 2 dimensional image into a set of 1 dimensional arrays of pixels containing the streak.

5. The method of claim 2, further comprising:
after identifying one or more locations of starting pixels, performing scatter-gather direct memory access (DMA) to accomplish pixel sorting as part of data transfer into a field programmable array (FPGA).

6. The method of claim 5, wherein the performing the scatter-gather DMA comprising
writing, by a host processor, memory address(es) of the starting pixels and a number of the plurality of pixels to be transferred into a table,
the table being stored in a database.

7. The method of claim 6, wherein the performing the scatter-gather DMA further comprising
reading, by the FPGA, the table to identify segments of memory to transfer the data from the database, and
performing, by the FPGA, the scatter-gather DMA to accomplish the transfer of the data.

8. The method of claim 7, wherein the performing the scatter-gather DMA further comprising
deserializing, by the FPGA, each horizontal row of pixels into a set of first-in-first-out (FIFO) channels to perform a pixel sorting operation.

9. The method of claim 7, wherein the performing the scatter-gather DMA further comprising
arranging, by the FPGA, each of the horizontal rows of pixels to align with the one of the plurality diagonal lines of pixels as an outcome of the data transfer.

10. A non-transitory computer readable medium comprising a computer program, the computer program configured to execute the following:
capturing one or more images of a plurality of stars and the one or more satellites;
sequentially or randomly selecting each one of a plurality of diagonal lines of pixels in the one or more images, the plurality of diagonal lines of pixels represent one of the plurality of stars in the one or more images;
applying a moving average filter to the selected one of the plurality of diagonal lines of pixels to find a location of one of the plurality of start on an x- and y-axis coordinate; and
providing the location of the one of the plurality of stars in the one or more captured images to be cross referenced with angular coordinates and radiometric quantities in stellar catalogs.

11. The computer-implemented method of claim 10, wherein the computer program is further configured to execute:
for each of the one or more captured images,
extracting a subset of pixels from each horizontal row of pixels in order to line the extracted subset of pixels with column.

12. The computer-implemented method of claim 11, wherein the extracting the subset of pixels comprising shifting the selected subset of pixels horizontally to match a known diagonal path traced by a streak representing the one of the plurality of stars.

13. The computer-implemented method of claim 12, wherein the shifting the selected subset of pixels comprising shifting a starting point of the selected subset of pixels horizontally and to the right to match the one of the plurality of diagonal lines of pixels, thereby transforming the one of the plurality of diagonal lines of pixels containing the streak within a 2 dimensional image into a set of 1 dimensional arrays of pixels containing the streak.

14. The method of claim 13, wherein the computer program is further configured to execute:
after identifying one or more locations of starting pixels, performing scatter-gather direct memory access (DMA) to accomplish pixel sorting as part of data transfer into a field programmable array (FPGA).

15. The method of claim 14, wherein the computer program is further configured to execute:
writing, by a host processor, memory address(es) of the starting pixels and a number of the plurality of pixels to be transferred into a table,
the table being stored in a database.

16. The method of claim 15, wherein the computer program is further configured to execute:
reading, by the FPGA, the table to identify segments of memory to transfer the data from the database, and
performing, by the FPGA, the scatter-gather DMA to accomplish the transfer of the data.

17. The method of claim 16, wherein the computer program is further configured to execute:
deserializing, by the FPGA, each horizontal row of pixels into a set of first-in-first-out (FIFO) channels to perform a pixel sorting operation.

18. The method of claim 16, wherein the computer program is further configured to execute:
arranging, by the FPGA, each of the horizontal rows of pixels to align with the one of the plurality diagonal lines of pixels as an outcome of the data transfer.

19. An apparatus for analyzing electro-optical imagery from a telescope observing one or more satellites, comprising:
at least one processor; and
memory comprising a set of instructions, wherein
the set of instructions, with the at least one processor, is configured to execute:
capturing one or more images of a plurality of stars and the one or more satellites;
sequentially or randomly selecting each one of a plurality of diagonal lines of pixels in the one or more images, the plurality of diagonal lines of pixels represent one of the plurality of stars in the one or more images;
applying a moving average filter to the selected one of the plurality of diagonal lines of pixels to find a location of one of the plurality of start on an x- and y-axis coordinate; and
providing the location of the one of the plurality of stars in the one or more captured images to be cross referenced with angular coordinates and radiometric quantities in stellar catalogs.
